(19) United States
(12) Patent Application Publication
(10) Pub. No.: US 2005/0206580 A1
(43) Pub. Date: Sep. 22, 2005

(54) Information display

(76) Inventors: Fumio Koyama, Nagano-ken (JP); Yoshiyuki Kodama, Chino-shi (JP); Dai Tanaka, Shiojri-shi (JP)

Correspondence Address: HARNESS, DICKEY & PIERCE, P.L.C., P.O. BOX 828, BLOOMFIELD HILLS, MI, 48303, US

(21) Appl. No.: 11/014,623

(22) Filed: Dec. 16, 2004

(30) Foreign Application Priority Data
Dec. 16, 2003 (JP) 2003-418404

(51) Int. Cl. G09G 5/00

(52) U.S. Cl. 345/1.1

(57) ABSTRACT

An information display 1 according to the present invention has an information carrier 10 including a storable display panel 14 separate from a processing unit 20 including a battery 27, and in the case where there is a need to perform a process such as updating or manipulating information displayed on the display panel 14, it is possible to perform a desired process by connecting the processing unit 20 to the information carrier 10. For that reason, it is possible, in normal use, to separate components other than those for maintaining “display” which is a fundamentally required function for a display close to “paper” from the information display 1. Therefore, it is possible to realize the information display having convenience capable of replacing the paper.

### BACKGROUND OF THE INVENTION

1. Field of the Invention

The present invention relates to an information display for displaying information which is a display object.

2. Description of the Related Art

Conventionally, it is common practice to print information on “paper” as a method of visibly representing the information.

As for printing the information on paper (so-called hard copy), it has been used and improved for ages so that excellent printing technology is established.

However, hard-copied information is in a state of being firmly fixed on paper, and so it is difficult to rewrite, erase or use such information as electronic information.

As regards displaying of general display information provided to a PC (Personal Computer) and so on (so-called soft copy), a display element is becoming increasingly lower-profile. And high definition and high contrast are realized in terms of display performance. In particular, a light and thin display medium called “electronic paper” is under development lately, which can hold natural display with no electricity by a reflection method based on a new display principle. It is anticipated as the one capable of realizing a display quality close to the hard copy. For instance, JP2002-169190A discloses a technique relating to such a display medium called the electronic paper.

As for information displays including such electronic paper as the display medium, there are various proposals of the ones using the electronic paper instead of conventional display media (nematic liquid crystal for instance) of the information displays such as a PDA (Personal Data Assistant).

The information display including the electronic paper as the display medium can realize reutilizability of the information by exploiting characteristics of the soft copy while realizing a conventional display quality close to “paper.” Therefore, it is anticipated as the one of a high utility value for replacing the paper.

However, the information display merely having a display medium portion of the conventional information display replaced by the electronic paper can hardly realize usability and viewability comparable to the “paper” or a book comprised of the paper.

To be more specific, it is difficult to realize free use conditions like the paper just by extending an idea of the conventional information display because the electronic paper has a processing portion for processing and displaying the information and a power supply for driving the electronic paper provided as one therewith.

The information display becomes expensive since it has such processing portion and power supply so that it is difficult for a user to possess multiple information displays. For that reason, it is difficult to think while referring to multiple display media at the same time as with the paper.

Furthermore, printing the information on paper allows the user to grasp the information which is an incorporeal thing as a sensuously reliable corporeal thing. However, the conventional information display for switching a screen as required cannot be used by the user as if it is the “paper.” To be more specific, in the case of displaying the information on the conventional information display, the displayed information easily disappears. Therefore, it is not possible to render the information as the corporeal thing and thereby handle it in a sensuously reliable form with a sense of security as in the case of printing on paper.

Thus, it is difficult to use the electronic paper instead of the paper in the case of merely replacing the display medium portion of the conventional information display by the electronic paper.

An object of the present invention is to realize a convenient information display replaceable by the paper.

To be more precise, it is to realize the information display capable of handling the information in a free usage pattern as with the paper and in a reassuring form as with the paper at relatively low cost.

### SUMMARY OF THE INVENTION

An information display according to the present invention is the one including a display section (a display panel 14 in FIG. 2 for instance) having a function of keeping a display state nonvolatile. It is the one wherein the display section is comprised of a unit (an information carrier 10 in FIG. 2 for instance) separate and detachable from at least one nondisplay unit (a processing unit 20 in FIG. 2 for instance) having a predetermined function other than the function of keeping display contents nonvolatile, and the units are capable of mutually cooperative operation.

With such a configuration, it is possible, in normal use, to separate from the information display those components other than the ones for maintaining “display” which is a fundamentally required function for a display close to “paper.”

Thus, it is possible to render an apparatus itself light-armed while combining good display quality close to the “paper” with reutilizability of information (function of handling displayed information as electronic data) so as to improve operability significantly in comparison with a conventional information display.

To be capable of mutually cooperative operation in this case, it needs to be configured to be capable of communication, information processing by mutually sending and receiving the information and supplying power from one unit to the other unit.

In such a configuration, it is also possible to store display data in a format to be displayed on the display section (data in an intermediate format or rasterized data in a preferred embodiment of the invention) generated from the data as a display object (document data in the preferred embodiment of the invention) in a memory provided on a nondisplay unit side.

Thus, it is no longer necessary to store the display data in the unit comprising the display section, and so it is possible to reduce costs.

Furthermore, it is also possible to provide a power supply for supplying the power to rewrite the display contents to the unit comprising the display section.

The information display according to the present invention is also the one wherein the display section is comprised of a storable display capable of keeping a display state without supplying the power (for instance, a an electrophoretic display, a cholesteric liquid crystal display, a display using a charged toner, a display using a twist ball or an electro-deposition display).

With such a configuration, it is possible to keep the display state nonvolatile on the display alone so as to easily render the display section as an independent unit. It is also possible to render the unit comprising the display section lighter-armed.

The display section includes a non-storable display requiring the power to keep the display state and a display keeping power supply for supplying the power to keep the display state.

With such a configuration, it is possible to simply realize a pseudo storable display by using the non-storable display.

The nondisplay unit is a unit having a display processing function of generating the display data in the form to be displayed on the display section from the data as the display object and the function of supplying the power for rewriting the display contents on the display section (processing units 20, 20a and 20b in FIGS. 1, 7 and 9 for instance).

In the case of such a configuration, the information display can have its main functions comprised of two units.

The nondisplay unit is also a unit having a display processing function of generating the display data in the form to be displayed on the display section (processing unit 20 in FIG. 6 for instance) from the data as the display object and a unit having the function of supplying the power for rewriting the display contents on the display section (power supply unit 30 in FIG. 6 for instance).

In the case of such a configuration, the information display can have its main functions comprised of three units.

It is also has a storage section for holding the data as the display object nonvolatile on the unit comprising the display section.

With such a configuration, it is possible to have the displayed information and its location as one so as to render the unit comprising the display section as the medium for handling the information as a corporeal thing as with the “paper.”

It also has the storage section for keeping the display data in the form to be displayed on the display section generated from the data as the display object nonvolatile on the unit comprising the display section.

With such a configuration, it is possible, even in the case of handling the unit comprising the display section with a different nondisplay unit, to perform a continuous process so as to alleviate a processing load of the nondisplay unit.

At least one of the unit comprising the display section and the nondisplay unit is configured as sharable by the nondisplay unit or the unit comprising the display section of another information display.

With such a configuration, it is possible to broadly utilize the unit comprising the display section.

For instance, it is possible to have the information stored in the unit comprising the display unit processed sequentially by multiple users with the nondisplay units belonging to them respectively so as to process the information as intended.

It is also possible, by having such a configuration, to have the process performed to multiple units comprising the display section by one nondisplay unit.

The unit comprising the display section has an instruction input section for inputting an instruction to the information display by a predetermined input operation, and the nondisplay unit becomes an operating instrument for performing the predetermined input operation.

For instance, it is possible to have a configuration in which the instruction input section is a button for detecting contact of the nondisplay unit and the nondisplay unit is a pen-shaped operating instrument so as to have an instruction inputted only by the nondisplay unit.

### BRIEF DESCRIPTION OF THE DRAWINGS

FIG. 1 is a diagram showing an external view configuration of an information display 1 according to the present invention;

FIG. 2 is a block diagram showing a functional configuration of the information display 1;

FIG. 3 is a diagram showing a configuration example in which a connection section 17 also has a function of an instruction input section 15 comprised of an electromagnetic user interface;

FIG. 4 is a diagram showing the configuration in which each information carrier 10 has an ID storage section for identifying each individual information carrier 10;

FIG. 5 is a diagram showing the configuration of the information carrier 10 having both a non-storable display element and a small power supply for maintaining a display state thereof instead of a storable display element;

FIG. 6 is a diagram showing an example in the case of comprising the information display 1 with three units of the information carrier 10, a processing unit 20 and a power supply unit 30;

FIG. 7 is a diagram showing an external view configuration of an information display 2 according to a second embodiment;

FIG. 8 is a diagram showing a functional configuration of the information display 2; and

FIG. 9 is a diagram showing an external view configuration of an information display 3 according to a third embodiment.

### DESCRIPTION OF THE PREFERRED EMBODIMENT

Hereunder, embodiments of an information display according to the present invention will be described by referring to the drawings.

### First Embodiment

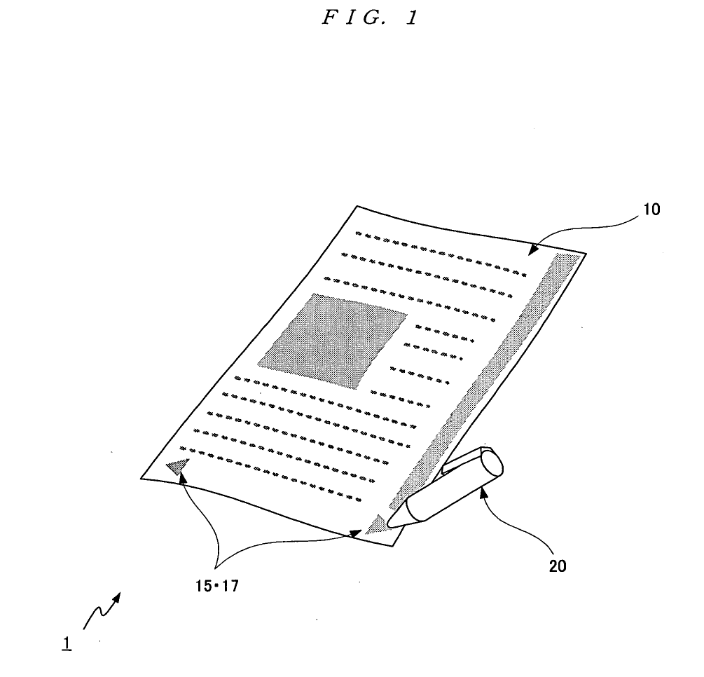

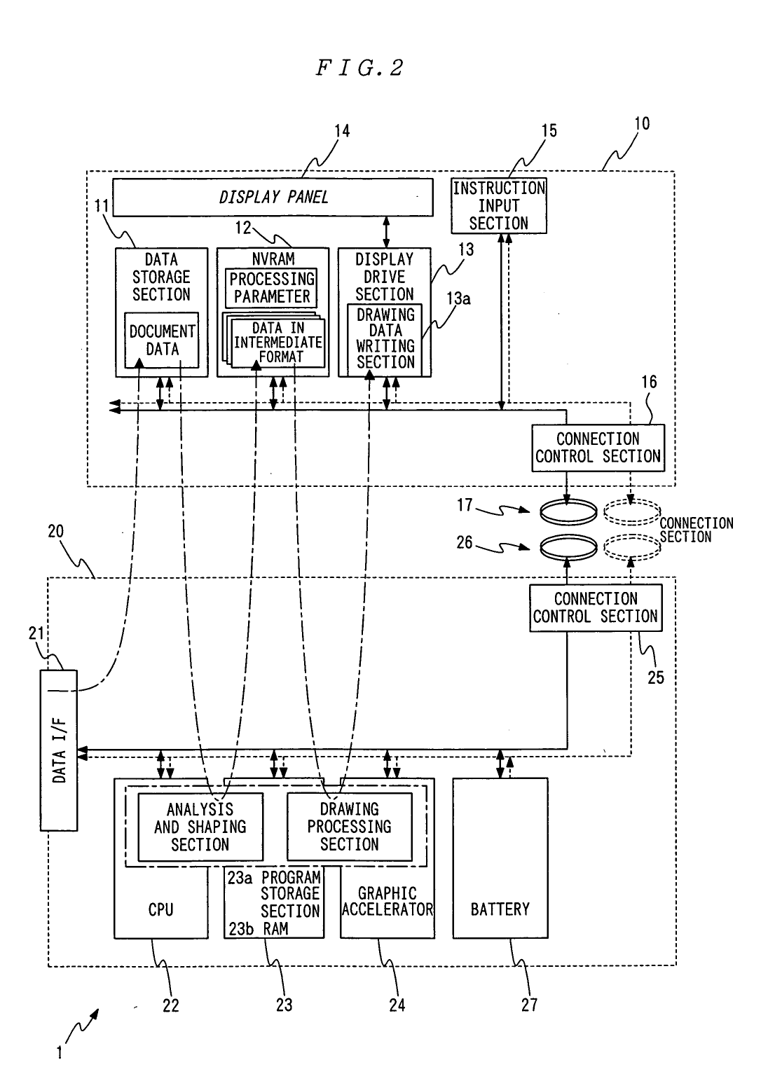

FIG. 1 is a diagram showing an external view configuration of an information display 1 according to a first embodiment of the present invention, and FIG. 2 is a block diagram showing a functional configuration of the information display 1.

In FIGS. 1 and 2, the information display 1 is comprised of an information carrier 10 in a light and thin form like paper and a pen-shaped processing unit 20

The information carrier 10 is comprised of a data storage section 11, an NVRAM (Non-Volatile Random Access Memory) 12, a display drive section 13, a display panel 14, an instruction input section 15, a connection control section 16 and a connection section 17, which are connected by a bus 18 to be capable of communication.

The data storage section 11 is comprised of a nonvolatile memory such as a flash memory, and is capable of storing data inputted from a data interface (hereafter, referred to as a “data I/F”) 21 via the connection section 17 described later.

The NVRAM 12 is comprised of a memory such as an FeRAM/FRAM (Ferroelectric Random Access Memory) or an MRAM (Magnetoresistive Random Access Memory), and forms a work area when a CPU 22 performs a process and also stores a processing result thereof.

The display drive section 13 directly controls the display panel 14 to have drawing data inputted from a graphic accelerator (hereafter, referred to as a “GA”) 24 described later displayed on the display panel 14.

To be more precise, the display drive section 13 has a drawing data writing section 13a to which the drawing data is inputted by the GA 24. And the display drive section 13 refers to the drawing data inputted to the drawing data writing section 13a and drives an X driver and a Y driver of the display panel 14 so as to have a raster figure as a drawing object displayed on the display panel 14.

As for a system for driving the display panel 14, it is possible to adopt a passive matrix drive system, a TFT (Thin Film Transistor) system, a TFD (Thin Film Diode) system or a D-TFD (Digital Thin Film Diode) system for instance.

The display panel 14 is comprised of a display of high pixel density (multi-pixel) of A4 size, and displays pixel data on predetermined pixels according to control of the display drive section 13.

A storable display (a display having its display screen maintained even after turning off the power) is used as the display panel 14. Therefore, no power is required to maintain a state of the display screen, and so it is possible to render the information display 1 less power-consuming.

As for the display panel 14, it is possible to adopt an electrophoretic display, a cholesteric liquid crystal display, a display using a charged toner, a display using a twist ball or an electro-deposition display.

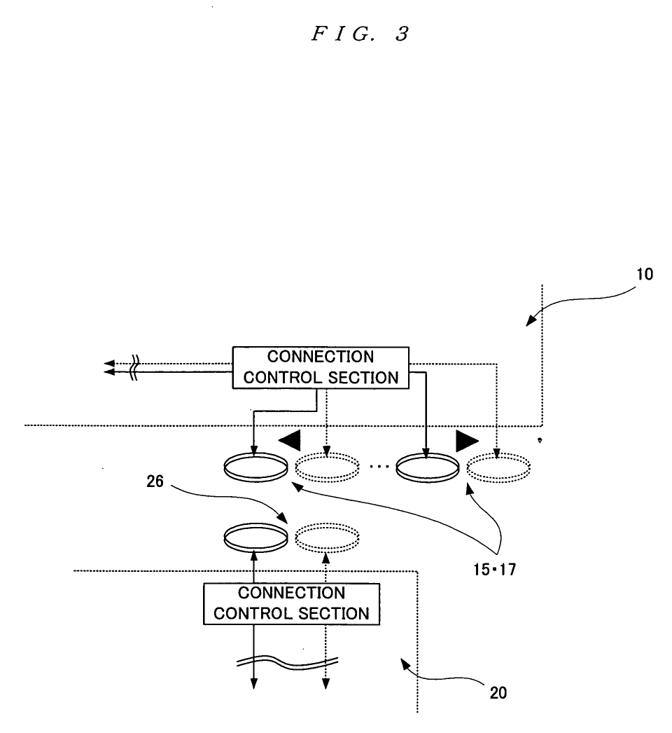

The instruction input section 15 has a predetermined user interface and accepts an instruction input by a user. The instruction input section 15 may be a mechanical interface such as a push button or an electromagnetic interface also having the function of the connection section 17 described later (refer to FIG. 3).

The connection control section 16 controls the input and output of information and power performed via the connection section 17.

To be more specific, the connection control section 16 converts parallel data inputted from the display drive section 13 or the instruction input section 15 to serial data to output it to the connection section 17, and also converts the serial data inputted from the connection section 17 to the parallel data to output it to the data storage section 11, NVRAM 12, display drive section 13 or instruction input section 15. As the connection control section 16 performs such a process and a connection control section 25 on the processing unit 20 performs the same process as will be described later, the information sent and received between the bus 18 and a bus 28 of the processing unit 20 is bidirectionally serial-converted so as to put the bus 18 and the bus 28 of the processing unit 20 in a state of an inter-bus connection.

The connection control section 16 detects supply of the power from the processing unit 20 via the connection section 17, and rectifies AC power inputted via the connection section 17 to output it to the data storage section 11, NVRAM 12, display drive section 13 or instruction input section 15.

The connection section 17 is the interface for inputting and outputting the information and power between the information carrier 10 and the processing unit 20. To be more precise, the connection section 17 has a coil for inputting and outputting the information and a coil for inputting and outputting the power, and connects them electromagnetically to two coils provided likewise to a connection section 26 of the processing unit 20 respectively so as to input and output the information and power. It is possible, between the connection section 17 and the connection section 26, to input and output the information and power simultaneously with the above-mentioned coils or input and output them by switching between them by time division in order to prevent mutual interference securely on conveying the information and power.

It is possible, by providing the connection sections 17 corresponding to different instruction input contents respectively, to have a configuration in which the connection sections 17 also have the function of the instruction input section 15 comprised of the electromagnetic user interface.

FIG. 3 is a diagram showing the configuration example in which the connection section 17 also has the function of the instruction input section 15 comprised of the electromagnetic user interface.

In FIG. 3, the connection section 17 on the left side has the function of the instruction input section 15 corresponding to a page-turning button in FIG. 2. If the processing unit 20 is connected to the connection section 17 on the left side, the power is supplied and the information is inputted and outputted, and the instruction to turn the page is also inputted. Likewise, the connection section 17 on the right side has the function of the instruction input section 15 corresponding to a page-turning-back button in FIG. 2. And if the processing unit 20 is connected to the connection section 17 on the right side, the power is supplied and the information is inputted and outputted, and the instruction to turn back the page is also inputted.

As for FIG. 3, a description was given as to an example in which the connection section 17 is provided at a position corresponding to each button. It is also possible, however, to provide the connection section 17 like a matrix all over the information carrier 10. It becomes possible, with such a configuration, to grasp the position on the information carrier 10 to which the processing unit 20 is connected so as to allow various processes such as selecting a displayed document.

Next, the processing unit 20 is comprised of the data I/F 21, CPU 22, storage section 23, GA 24, connection control section 25, connection section 26 and a battery 27, which are connected by the bus 28 to be capable of communication.

The data I/F 21 is the interface capable of inputting the data from outside the processing unit 20, and is comprised of a communication interface or a slot of a storage medium for instance. And the data inputted via the data I/F 21 is outputted from the connection section 26 to the information carrier 10, and is stored in the data storage section 11 of the information carrier 10.

The CPU 22 controls the entire information display 1, and reads and executes programs relating to various processes stored in a program storage section 23a of the storage section 23 according to various instruction signals inputted from the instruction input section 15. And the CPU 22 performs the process for displaying content data stored in the data storage section 11 or the storage medium inserted into the data I/F 21 on the display panel 14. The CPU 22 stores various processing results in an RAM 23b of the storage section 23.

The storage section 23 has the program storage section 23a comprised of a nonvolatile memory such as a flash memory, which has various programs for controlling the information display 1 stored therein.

The storage section 23 also has the RAM 23b comprised of a volatile memory such as a DRAM (Dynamic Random Access Memory) or an SRAM (Static Random Access Memory), which can temporarily hold various data generated when the CPU 22 performs the process. As for the RAM 23b, the SRAM capable of holding the data at low power consumption is desirable, and the nonvolatile FeRAM/FRAM or MRAM is more desirable.

The GA 24 is hardware capable of performing a drawing process of an image to be displayed on the display panel 14 at high speed according to an order of the CPU 22. To be more precise, the GA 24 performs a process such as developing a vector figure inputted from the CPU 22 into a raster figure. And the GA 24 outputs the drawing data for drawing a figure having undergone the drawing process on the display panel 14 to the display drive section 13.

The connection control section 25 controls the input and output of the information and power performed via the connection section 26. To be more specific, the connection control section 25 converts the parallel data inputted from the CPU 22, storage section 23, GA 24 or battery 27 to serial data to output it to the connection section 26, and also converts the serial data inputted from the connection section 26 to the parallel data to output it to the CPU 22, storage section 23, GA 24 or battery 27. The connection control section 25 also renders DC power inputted from the battery 27 as AC to output it to the connection section 26.

The connection section 26 is the interface for inputting and outputting the information and power between the information carrier 10 and the processing unit 20. To be more specific, the connection section 26 has a coil for inputting and outputting the information and a coil for inputting and outputting the power, and connects them electromagnetically to the two coils provided likewise to the connection section 17 of the information carrier 10 respectively so as to input and output the information and power.

The battery 27 is comprised of a primary battery or a secondary battery, and supplies the power to the sections of the information display 1.

Under the above-mentioned configuration, it is possible to realize an analysis and shaping section 110 and a drawing processing section 120 shown in FIG. 2 by having a predetermined program executed by the information display 1.

The analysis and shaping section 110 converts document data stored in the data storage section 11 to an intermediate format. To be more precise, it breaks down the document data into drawing elements and describes it in a form displayable at high speed (intermediate format).

The drawing processing section 120 performs the drawing process for displaying the data converted to the intermediate format by the analysis and shaping section 110 on the display panel 14. For instance, the drawing processing section 120 performs the process for rasterizing the drawing elements included in the intermediate format.

Next, operation will be described.

The information display 1 according to the present invention has the connection section 17 of the information carrier 10 and the connection section 26 of the processing unit 20 electromagnetically connected so as to supply the power from the processing unit 20 to the information carrier 10;and allow the input and output of the information. Thus, the entire information display 1 becomes operable.

And if the document data is inputted via the data I/F 21 of the processing unit 20, the document data is stored in the data storage section 11 of the information carrier 10. In the case where the data I/F 21 is the slot of the storage medium, it is also possible to read and use the data directly from the storage medium inserted into the slot without storing it in the data storage section 11.

Then, the analysis and shaping section 110 configured on the processing unit 20 starts processing the document data. To be more specific, the analysis and shaping section 110 interprets document structure of the document data, and performs a layout process for screen display according to that structure. And the analysis and shaping section 110 stores the document data having undergone the layout process in the NVRAM 12 as the data in the intermediate format.

In this case, the NVRAM 12 of the information carrier 10 is also used as a static data area (an area for storing the data representing the state of processing such as a page number currently in process).

Next, the drawing processing section 120 generates the drawing data from the data in the intermediate format stored in the NVRAM 12, and writes it to the drawing data writing section 13a of the display drive section 13.

Then, the display drive section 13 drives the display panel 14 according to the drawing data written to the drawing data writing section 13a so that a document is displayed on the display panel 14.

If the processing unit 20 is separated from the connection section 17, no power is supplied to the information carrier 10 so that the operation of the sections comes to a stop.

As the display panel 14 is storable, however, the state of being displayed is continuously maintained even after the supply of the power from the processing unit 20 is stopped. Likewise, static data and the data in the intermediate format stored in the NVRAM 12 are also held due to nonvolatility of the NVRAM 12. Furthermore, the data storage section 11 is also a nonvolatile memory, and so the document data stored therein is also held.

Thus, the information carrier 10 can keep displaying the information even in the state of no supply of the power, that is, the state of the information carrier 10 alone separated from the processing unit 20. Therefore, it can realize the operability close to that of the paper.

Furthermore, if the processing unit 20 once separated is connected to the information carrier 10 again, the CPU 22 checks the static data stored in the NVRAM 12 and continues a display process of the document data form a current display state in the case where it is determined to be valid data. As to whether or not the static data stored in the NVRAM 12 is valid, it can be determined by whether or not its data format is suited as a processing object of the processing unit 20 or by a check sum added in advance to the static data.

As the processing unit 20 is an operating instrument for the information carrier 10 according to this embodiment, in the case where the user performs the operation such as turning the page, the operation of separating the processing unit 20 from the information carrier 10 and reconnecting it thereto is sequentially performed as described above. To be more specific, in the case where the user performs the operation, the processing unit 20 is connected to the information carrier 10 so as to input the instruction signal to turn the page via the instruction input section 15 or from an unshown instruction button provided to the processing unit 20.

Then, the inputted instruction signal is inputted to the CPU 22, and the CPU 22 performs the process according to the instruction.

As the processing unit 20 is an operating instrument for the information carrier 10 according to this embodiment, in the case where the user performs the operation such as turning the page, the operation of separating the processing unit 20 from the information carrier 10 and reconnecting it thereto is sequentially performed as described above. To be more specific, in the case where the user performs the operation, the processing unit 20 is connected to the information carrier 10 so as to input the instruction signal to turn the page via the instruction input section 15 or from an unshown instruction button provided to the processing unit 20.

Then, the inputted instruction signal is inputted to the CPU 22, and the CPU 22 performs the process according to the instruction.

Thus, the information related to the displayed document (document data, data in the intermediate format and static data) is stored on the information carrier 10, and thus no data inseparable from the connected information carrier 10 is left on the processing unit 20. Therefore, it is possible to change the connected information carrier 10 to something different in arbitrary timing.

As described above, the information display 1 according to this embodiment has the information carrier 10 including the storable display panel 14 separate from the processing unit 20 including the battery 27. And in the case where there is a need to perform the process such as updating or manipulating the information displayed on the display panel 14, it is possible to perform the desired process by connecting the processing unit 20 to the information carrier 10.

For that reason, it is possible, in normal use, to separate components other than those for maintaining the “display” which is a fundamentally required function for the display close to “paper” from the information display 1.

Thus, it is possible to render an apparatus itself light-armed while combining good display quality close to the “paper” with reutilizability of the information (function of handling displayed information as electronic data) so as to improve operability significantly in comparison with a conventional information display.

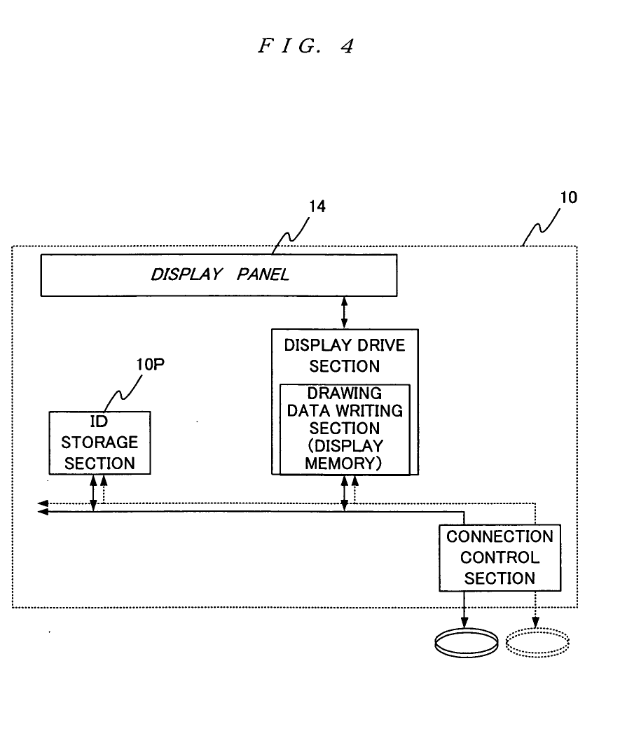

It is also possible, by configuring the information carrier 10 of this embodiment as shown in FIG. 4, to handle multiple information carriers 10 while identifying each of them.

FIG. 4 shows the configuration in which each of the information carriers 10 includes an ID storage section 10P for identifying each of the information carriers 10.

In the case of such a configuration, it is feasible to have the multiple information carriers 10 operated by one processing unit 20 while performing various kinds of management with an ID. To be more precise, even in the case where the data as a display object is stored in the processing unit 20 or in a server on a network, it can be associated with the information carriers 10. Therefore, it is possible to widen applications of the information display 1.

This embodiment described an example in which the display panel 14 includes a storable display element. It is also feasible, however, to have a configuration in which a non-storable display element and a small power supply for maintaining the display state thereof are combined instead of the storable display element.

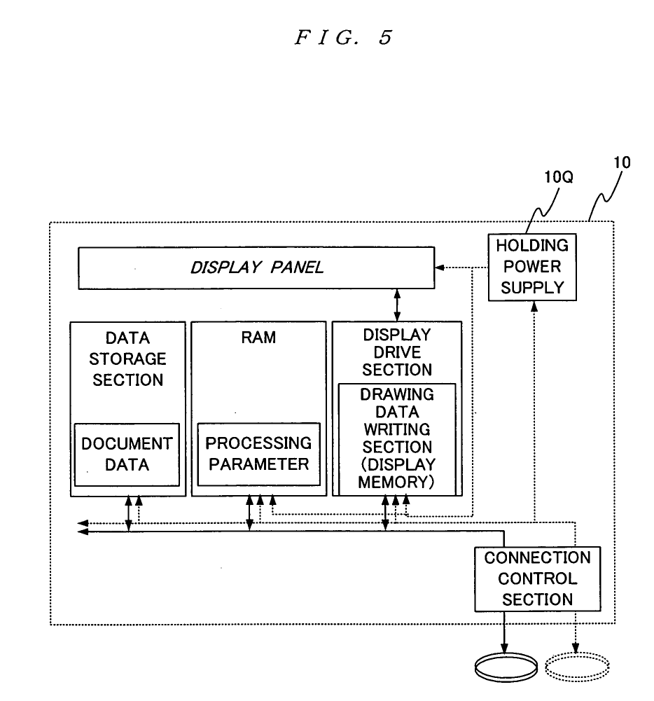

FIG. 5 is a diagram showing the configuration of the information carrier 10 having both the non-storable display element and small power supply (holding power supply 10Q) for maintaining the display state thereof instead of the storable display element.

With such a configuration, it is possible, even in the case of using the non-storable display element, to substantially use it as the storable display element.

This embodiment also described the configuration in which the CPU 22, storage section 23 and GA 24 are provided to the processing unit 20. However, the components other than the battery 27 may be provided to either the processing unit 20 or the information carrier 10.

Furthermore, this embodiment described the example of supplying the power from the processing unit 20 to the information carrier 10. It is also feasible, however, to have a configuration in which a power supply unit for supplying the power to the information carrier 10 is separate from the processing unit 20.

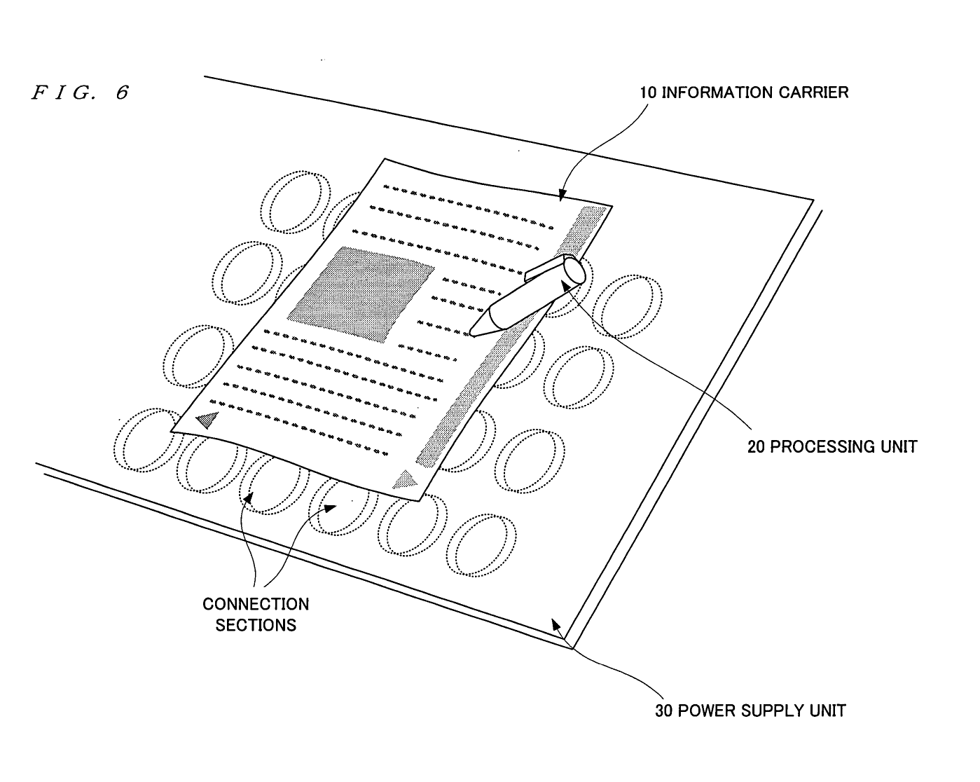

FIG. 6 is a diagram showing an example in the case of configuring the information display 1 with three units of the information carrier 10, processing unit 20 and a power supply unit 30.

In FIG. 6, the information carrier 10 has the connection section 17 provided on a backside thereof to be electromagnetically connectable to the coil on the power supply unit 30 side which is embedded in a desk mat or a desk surface.

In the case of rewriting the information displayed on the information carrier 10, the information is processed by the processing unit 20 while the power for rewriting is supplied from the power supply unit 30.

With such a configuration, it is possible, as a method of use, to arrange the multiple information carriers 10 on the desk surface and have them sequentially operated with one processing unit 20 by the user.

### Second Embodiment

Next, a second embodiment of the present invention will be described.

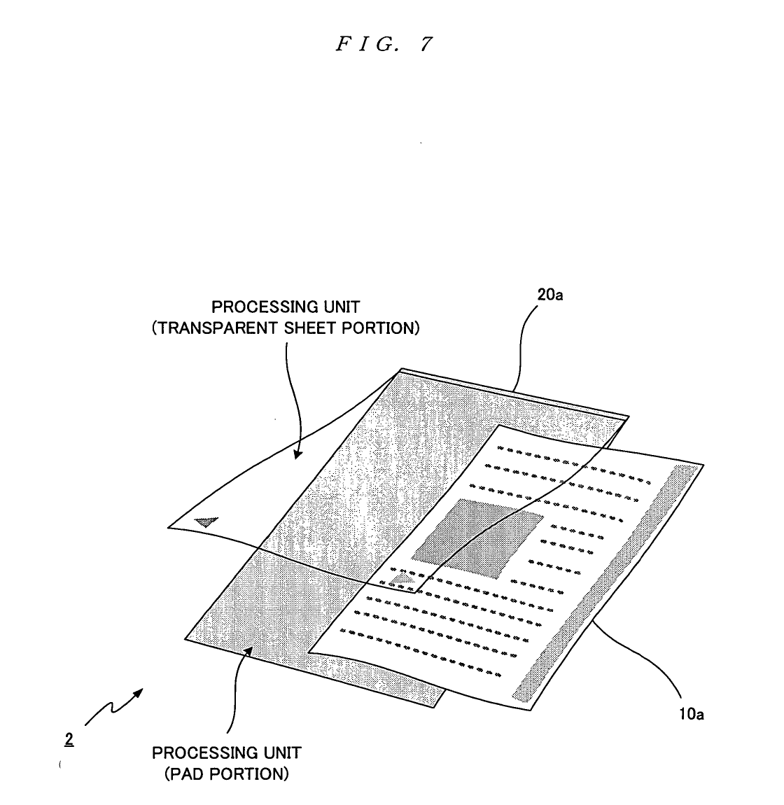

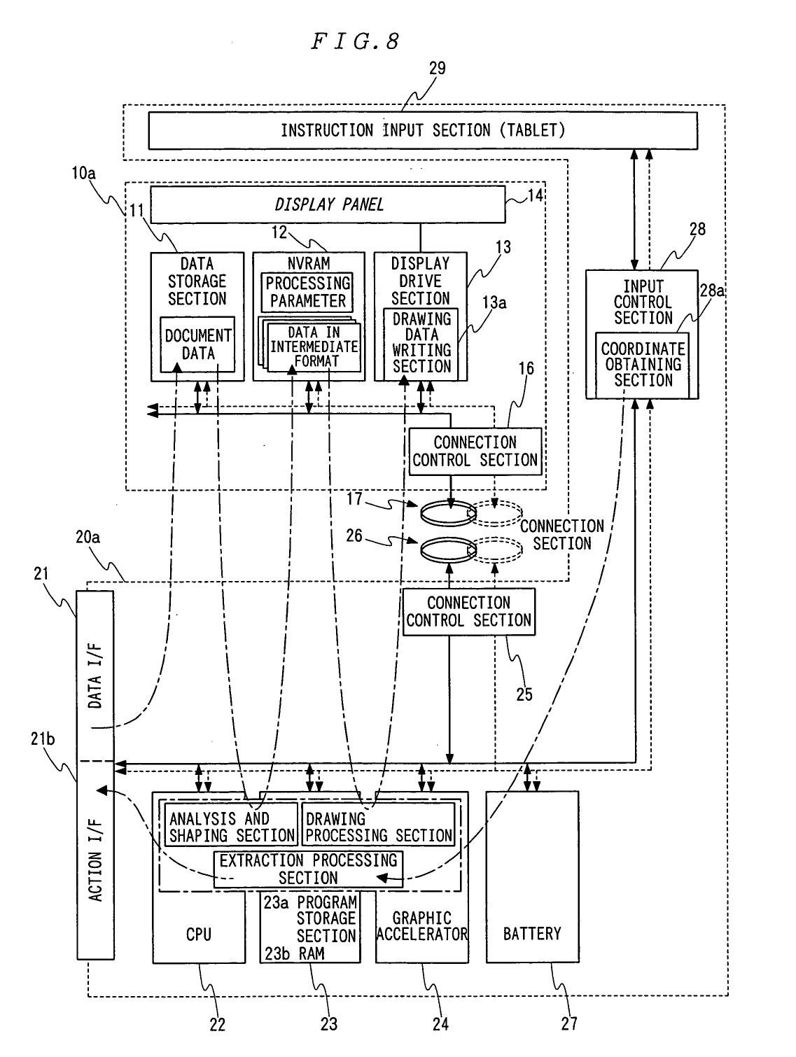

FIG. 7 is a diagram showing an external view configuration of an information display 2 according to this embodiment, and FIG. 8 is a diagram showing a functional configuration of the information display 2.

In FIGS. 7 and 8, the information display 2 is comprised of an information carrier 10a and a processing unit 20a.

As shown in FIG. 8, the functional configuration of the information carrier 10a and processing unit 20a includes a portion in common with that of the information carrier 10 and a processing unit 20 of the first embodiment. Therefore, FIG. 2 should be referred to as to the common portion while only a different portion will be described here.

The information carrier 10a has almost the same functional configuration as the information carrier 10 of the first embodiment except that the instruction input section 15 is not provided thereto. However, the information carrier 10a has the connection section 17 mounted at a location different from the information carrier 10 of the first embodiment.

To be more specific, the connection section 17 of the information carrier 10a is provided at each of four corners of the backside of the information carrier 10a (the backside of the display screen). It is mounted in a positional relation corresponding to the connection section 26 provided on a pad of the processing unit 20a as will be described later.

As shown in FIG. 7, the processing unit 20a is configured in a form of a pad with a transparent sheet, where the information carrier 10a is sandwiched between the pad (a lower substrate) and the transparent sheet (upper sheet) and the processing unit 20a is thereby connected to the information carrier 10a.

The connection section 26 of the processing unit 20a is provided at each of the four corners of the top face of the pad. The four connection sections 26 are mounted to be opposed to the four connection sections 17 of the information carrier 10a in the case where the information carrier 10a is sandwiched between the pad and the transparent sheet.

Furthermore, the processing unit 20a is comprised of an action interface (hereafter, referred to as an “action I/F”) 21b, an input control section 28 and an instruction input section 29.

The action I/F 21b is the interface for conveying the information to other apparatuses such as the communication interface, and is capable of, by performing input operation to the instruction input section 29, sending the data such as a character string selected by the user to another apparatus such as a PC or a printer or another information display 1 via the action I/F 21b.

The input control section 28 has a function of the interface for controlling a signal input from the instruction input section 29, and receives an input signal generated by the instruction input section 29 so as to output a processing result to the sections such as the CPU 22 after performing a predetermined process. For instance, the input control section 28 has a coordinate obtaining section 28a for calculating a coordinate of a contact position in the case where the user contacts an input surface of the instruction input section 29 so as to output the calculated coordinate of the contact position to the sections such as the CPU 22.

The instruction input section 29 is comprised of the transparent sheet having a function of a touch tablet, and has the input surface capable of receiving the instruction input to the information display 2 from the user. The input surface of the instruction input section 29 is configured to have almost the same size as a display surface of the display panel 14. And in the case where the instruction input section 29 is lapped over the display surface of the display panel 14, the coordinate on the input surface of the instruction input section 29 and the coordinate on the display surface of the display panel 14 are associated with each other.

To be more specific, when getting sandwiched between the pad and the transparent sheet of the processing unit 20a, the information carrier 10a has the four connection sections 17 positioned to be approximately opposed to the four connection sections 26 mounted on the top face of the pad respectively.

And the coordinates are set on the transparent sheet with reference to the positions of the connection sections 26 so that the coordinate of the contact position is identified if the user contacts the transparent sheet. As it is difficult to exactly position the transparent sheet and the information carrier 10a, it is also possible to correct a positioning state of the transparent sheet and the information carrier 10a based on a balance of signal power of each of the combinations of the four connection sections 17 and 26.

The coordinates in common with those on the transparent sheet are set on the display surface of the display panel 14 of the information carrier 10a with reference to the positions of the connection sections 17 so that the corresponding position on the display surface of the display panel 14 is identified if the user contacts the transparent sheet and the coordinate of the contact position is identified.

Therefore, in the case where the user contacts the input surface of the instruction input section 29 (transparent sheet) in order to select the information displayed on the display panel 14, the CPU 22 can grasp the information on the display panel 14 corresponding to the contact position.

It is possible, under the above-mentioned configuration, to realize the analysis and shaping section 110, drawing processing section 120 and an extraction processing section 130 shown in FIG. 8 by having the predetermined program executed by the information display 2.

The analysis and shaping section 110 and drawing processing section 120 are the same as those in the first embodiment, and so a description thereof will be omitted.

The extraction processing section 130 identifies the information displayed on the display panel 14 based on the position on the input surface of the instruction input section 29 contacted by the user. The extraction processing section 130 can also send an element of document data (text or an image) corresponding to the identified information to another apparatus via the action I/F 21b or copy and paste it.

Next, the operation will be described.

As for the information display 2, the process until the document is displayed on the display panel 14 is the same as that of the information display 1.

And if the user selects the information such as the character string displayed on the display panel 14 via the instruction input section 29, the extraction processing section 130 identifies the element such as the text or image of the document data as to the selected information.

Furthermore, the extraction processing section 130 obtains the identified element from the data storage section 11.

Consequently, the information display 2 can send the information as the object of the input operation performed by the user (user action) to another apparatus via the action I/F 21b or copy and paste it on another portion of the display panel 14.

As described above, the information display 2 according to this embodiment has the information displayed on the display panel 14 associated with the element of the document data. And if the user performs the input operation to the information displayed on the display panel 14, the element of the document data corresponding thereto is obtained.

Therefore, it is possible to utilize the information displayed on the display panel 14 as the electronic data.

### Third Embodiment

Next, a third embodiment of the present invention will be described.

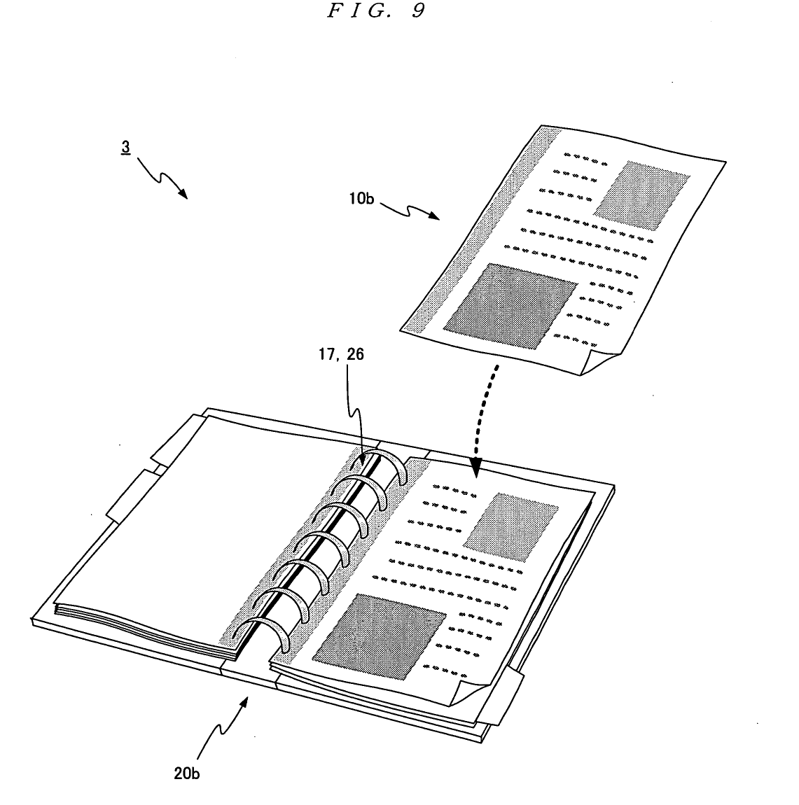

FIG. 9 is a diagram showing an external view configuration of an information display 3 according to this embodiment.

In FIG. 9, the information display 3 is comprised of an information carrier 10b and a processing unit 20b.

The information carrier 10b has the same configuration as the information carrier 10a of the second embodiment except the connection section 17.

The information carrier 10b has staple holes to be penetrated by ring-shaped staples for the sake of binding the information carrier 10b with the processing unit 20b, where the connection sections 17 are comprised of the staples and staple holes penetrated by the staples.

To be more specific, the staples and staple holes configure electrical contacts or the electromagnetic interface via which the information carrier 10b and processing unit 20b send and receive the information.

The processing unit 20b has the external view configuration in a binder form. The processing unit 20b also has the ring-shaped staples, and is capable of binding the information carrier 10b in a form of binding a binder leaf. Furthermore, the processing unit 20b can bind multiple information carriers 10b with the staples and can also send and receive the information by identifying the information carriers 10b via the staples as the connection sections 17.

To be more precise, a seven-digit identification code is assigned to each of the information carriers 10b. When inputting and outputting the information, a code of “0” or “1” is outputted to each of the seven ring portions in FIG. 9 so as to identify the seven-digit identification code. Then, the information carriers 10b are uniquely identified, and it becomes possible to have the information inputted and outputted between a specific information carrier 10b and the processing unit 20b.

It is also possible to secure a part of the seven ring portions for the sake of supplying the power.

Next, the operation will be described.

As for the information display 3, the process until the information is displayed on each information carrier 10b is the same as that of the information display 1.

And the information display 3 has a piece of the data stored on each information carrier 10b, and has multiple information carriers 10b, that is, multiple pieces of the data stored in the processing unit 20b. Thus, the information display 3 has a function of a card-type database.

In the case of browsing or transferring the information, it is possible to remove the information carriers 10b from the processing unit 20b with the information displayed and the document data stored as-is.

Therefore, it is possible to browse the information carrier 10b storing a specific piece of the information by separating it from the processing unit 20b and also use the document data stored on the information carrier 10b in another processing unit 20b.

In the above-mentioned configuration, it is also possible for the processing unit 20b to extract and calculate the data of a predetermined field on the information carrier 10b, update the calculated data of the information carrier 10b and perform the same process collectively to the multiple information carriers 10b which are bound.

As described above, the information display 3 according to this embodiment can handle the information stored in the information carrier 10b with convenience like the leaf bound by a binder.

Therefore, it is possible to handle the information which is an incorporeal thing as a corporeal thing so as to construct an intuitively understandable database.

It is also possible to have the information stored in the information carrier 10b handled as the electronic data by the processing unit 20b so as to easily process the information stored in the information carrier 10b.

Thus, according to the present invention, it is possible to secure a high degree of freedom in the configuration of the information displays 1 to 3 and render the portion including the display panel 14 lightweight so as to render the operability of the portion including the display panel 14 closer to that of the paper.

To be more specific, according to the present invention, it is possible to realize the information display having the convenience capable of replacing the paper.

To be more precise, it is possible to realize the information display capable of handling the information in a free usage pattern as with the paper and in a reassuring form as with the paper at relatively low cost.

1. An information display including a display section having a function of keeping a display state nonvolatile, wherein:
the display section is comprised of a unit separate and detachable from at least one nondisplay unit having a predetermined function other than the function of keeping display contents nonvolatile; and
the units are capable of mutually cooperative operation.

2. The information display according to claim 1, wherein the display section is comprised of a storable display capable of keeping a display state without supplying power.

3. The information display according to claim 1, wherein the display section includes a non-storable display requiring the power to keep the display state and a display keeping power supply for supplying the power to keep the display state.

4. The information display according to claim 1, wherein the nondisplay unit is a unit having a display processing function of generating display data in a form to be displayed on the display section from data as a display object and a function of supplying the power for rewriting the display contents on the display section.

5. The information display according to claim 1, wherein the nondisplay unit is a unit having the display processing function of generating the display data in the form to be displayed on the display section from the data as the display object and a unit having the function of supplying the power for rewriting the display contents on the display section.

6. The information display according to claim 1, wherein it has a storage section for holding the data as the display object nonvolatile on the unit comprising the display section.

7. The information display according to claim 1, wherein it has the storage section for keeping the display data in the form to be displayed on the display section generated from the data as the display object nonvolatile on the unit comprising the display section.

8. The information display according to claim 1, wherein at least one of the unit comprising the display section and the nondisplay unit is configured as sharable by the nondisplay unit or the unit comprising the display section of another information display.

9. The information display according to claim 1, wherein the unit comprising the display section has an instruction input section for inputting an instruction to the information display by a predetermined input operation, and the nondisplay unit becomes an operating instrument for performing a predetermined input operation.
